(19) United States
(12) Patent Application Publication
(10) Pub. No.: US 2022/0167592 A1
(43) Pub. Date: Jun. 2, 2022

(54) Pet Leash Extender

(71) Applicant: David MacGregor, Alton Bay, NH (US)

(72) Inventor: David MacGregor, Alton Bay, NH (US)

(21) Appl. No.: 17/106,643

(22) Filed: Nov. 30, 2020

(51) Int. Cl. A01K 27/00

(52) U.S. Cl. CPC A01K 27/003

(57) ABSTRACT

A leash extender with a larger round wrist loop and a smaller round handle loop connected by an extension. A user will wrap the leash extender around the handle of a pet leash and pass the wrist loop through the handle loop and pull securely. The leash extender is made of a soft, flexible material and has no edges, so is very comfortable around the user's wrist.

### FIELD OF THE INVENTION

The present invention relates generally to pet accessories, and particularly to pet leash accessories.

### BACKGROUND

There are approximately 90,000,000 pet dogs in the United States alone. These dogs need to be walked. Retractable leashes are a popular option. Such retractable leashes include a housing for the retractable line that includes a handle for the walker. A rambunctious dog can yank that handle out of the walker's hand. Moreover, some walker's, for a variety of reasons, may lack the dexterity or strength to hold onto that handle, but still want the convenience of the retractable handle. Finally, some walkers may wish to walk their dogs while still having both of their hands free. Therefore there is a need for a device that allows for use of a retractable leash without having to use its handle.

There are leashes that wrap around the walker's wrist, but these do not have the convenience of being retractable. There are safety straps that wrap around the user's wrist and through the handle of the retractable leash, but these safety straps are made of rough material that is inflexible and easy to get twisted, and that will chafe the walker's wrist if pulled too tightly or too quickly. Such safety straps also include buckles and other devices for adjusting the straps that make them unwieldy and difficult to use.

### SUMMARY OF THE INVENTION

The present invention is a leash extender. Although it is presented herein primarily in conjunction with use with a retractable leash, it is understood that it may be used with any leash with a handle.

In its most basic form, the leash extender of the present invention includes a substantially round wrist loop; a substantially round handle loop; and an extension between the wrist and handle loops. As used herein, the term “substantially round” includes, non-exclusively, circles, ellipses, egg-shapes, ovals, and importantly, any of the foregoing where the shape may appear slightly stretched toward a certain point. “Substantially round” does not include any straight edges or hard points and angles. The wrist loop is bigger than the handle loop, meaning that a radius of the substantially round wrist loop would be greater than a radius of the substantially round handle loop. Where the respective substantially round loops have non-circular shapes that may have many radii, such as an ovular shape, the radius of the wrist loop and the radius of the handle loop being compared would be the averages of those radii. The leash extender is made of a flexible material. Each of the wrist loop, the handle loop, and the extension has a rounded cross section. As used herein, “rounded” means having no sharp edges.

The flexible material allows the leash extender of the present invention to stretch but not break upon stretching. This characteristic of the leash extender is very useful when an unpredictable dog is intermittently pulling on its leash. It is preferred that the flexible material out of which the leash extender is made is polychloropene, commonly known by the tradename NEOPRENE. It is an inherent characteristic of polychloropene that it will maintain its shape or bounce back into its shape after being manipulated. This characteristic is considered to a be an aspect of the present invention. Due to this characteristic, if crumpled, bent, crushed, stretched, or made subject to any other abuse common to well-used items, the leash extender of the present invention will always return to its original round loops, which are soft and have no hard angles or points to irritate the walker's skin. It is notable that there are some existing products with a double loop structure that are used in non-comparable arts, such as weight lifting or as tie downs, but such products could not function as intended if they were flexible. The flexibility of the leash extender of the present invention, on the other hand, is a key aspect of the invention. Moreover, these other products tend to be flat bands made of material that would cut into and chafe one's wrist, unlike the soft polychloropene of the present invention.

The leash extender is wrapped around the handle of the leash and attached thereto by passing the wrist loop through the handle loop. The leash extender is then pulled tight for secure attachment to the leash handle. Once the wrist loop is passed through the handle loop, it will bounce back to its soft, roundness, as discussed above. The wrist loop will go around the walker's wrist. Its soft, rounded structure will be comfortable against the walker's skin and will not chafe if pulled tight, such as by a yanking dog.

It is preferred that the leash extender of the present invention have a fairly uniform height, even if its various components may have different widths. That is to say, when the preferred leash extender is viewed from the side when it is placed on a flat surface, one would view a consistent height down the length of the leash extender. It is preferred that the wrist loop and extension have a greater width than the handle loop, however. This may be explained by the rounded cross sections of the wrist loop, extension, and handle loop being oblong. As such, the wrist oblong cross section would have a wrist major axis and a wrist minor axis; the extension oblong cross section would have an extension major axis and an extension minor axis; and the handle oblong cross section would have a handle major axis and a handle minor axis. It is preferred that while the wrist minor axis and the handle minor axis are equal, the wrist major axis is greater than the handle minor axis. Moreover, it is preferred that the wrist major axis and the extension minor axis be equal and the wrist minor axis and the extension minor axis be equal. Regardless, it is preferred that the minor axes of each be equal, creating that height uniformity as described above. It is preferred that the respective major axes be greater than their related minor axes, but in some cases, the major axes are equal to or less than the minor axes. In one preferred embodiment, for example, the wrist major axis and the extension major axis are each 0.75″; the handle major axis is 0.38″; and the wrist minor axis, extension minor axis, and handle minor axis are all each 0.2″.

The leash extender of the present invention includes a total length and an extension length. The total length is measured between the farthest point on the wrist loop from the handle loop and the farthest point on the handle loop from the wrist loop. The extension length is measured from the nearest point on the wrist loop to the handle loop and the nearest point of the handle loop to the wrist loop. It is preferred that the extension length be between 45-55% of the total length. In one preferred embodiment, for example, the total length is 9.96″ and the extension length is 4.78″.

In some embodiments, the leash extender includes wrist padding around the wrist loop. This provides extra cushion for the user's wrist and also decreases wear and tear on the wrist loop. The wrist padding is preferably made of elastane, commonly known by the tradename LYCRA. The elastane is preferably stitched within the polychloropene. The wrist padding may also be secured in place through other means commonly used in the art, such as gluing. In some embodiments, the leash extender also includes handle padding, such as elastane padding, within the handle loop. The extension may also include extension padding. In some embodiments, the handle loop includes handle padding and/or the extension includes extension padding, but the wrist loop does not include wrist padding.

It is preferred that the wrist loop, the extension, and the handle loop of the leash extender are integrated. As used herein, “integrated” means that these components are formed from a single piece of material, again preferably polychloropene. The polychloroprene or other material is preferably die cut into the designed shape. The single piece avoids the complexity of buckles and other components and makes it easy to fold and place comfortably in one's pocket, for example. For the avoidance of doubt, integrated may indicate that the leash extender is a single piece with no seams, or that it is a single piece that connects to itself through one or more seams. One end of the handle loop and/or the wrist loop may attach to the extension to form the loop structure(s). This attachment may be through stitching, gluing, or any other means commonly used in the art. Regardless, the leash extender is always a single, simple, integrated piece, unlike existing products with a similar function.

The aspects of the present invention, presented above, lead to many advantages of the present invention. The leash extender prevents the walker from losing control of the dog, and keeps the dog from escaping, even if the leash is dropped after being yanked from the walker's hand. It provides convenient, hands-free usage, allowing the walker to carry items (e.g., grocery bags) or to complete manual tasks (e.g., using keys to unlock a door), while maintaining control over the pet. Because the leash extender attaches the leash to the walker's wrist, even when grip is lost, the dog is still attached to the walker. This stops the dog from getting loose and out of the handler's control, and prevents the leash from retracting and hitting the dog in the feet and legs. Other devices used for a similar purpose are complicated, uncomfortable, multi-pieced, and more difficult to use. The leash extender of the present invention quickly slips on and off the wrist when the walker contracts his or her hand; is prevented from sliding off the wrist by simply expanding fingers outward; is a single piece; is pliable, comfortable, durable, and stretchy; and folds easily and fits neatly in a pocket. The leash extender is also an aesthetically pleasing device that can be printed in any number of interesting and fashionable designs and colors or with personalization, like logos or other information.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1A is a top down view of the leash extender of the present invention.

FIG. 1B is a side view of the leash extender shown in FIG. 1A.

FIGS. 2A-C are cross sections of the wrist loop, extension, and handle loop, respectively.

FIGS. 3A and 3B are top down views of the leash extender of the present invention with padding.

### DETAILED DESCRIPTION

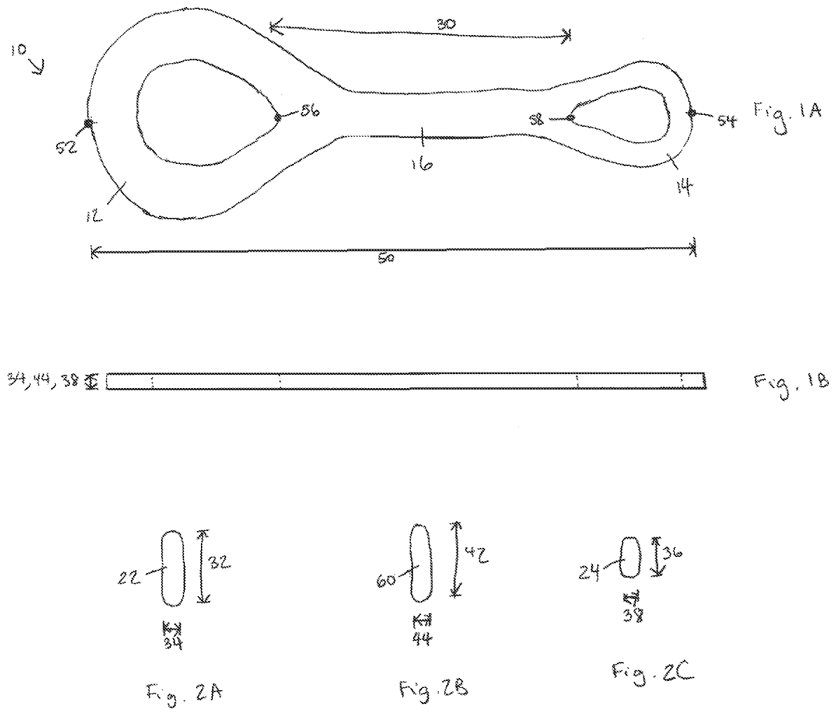

Referring first to FIG. 1A, a top down view of leash extender 10 of the present invention is provided. Leash extender 10 of the present invention includes a substantially round wrist loop 12; a substantially round handle loop 14; and an extension 16 between the wrist and handle loops 12, 14. Wrist loop 12 is bigger than handle loop 14, as considering their respective radii. Wrist loop 12, extension 16, and handle loop 14 of leash extender 10 are integrated. “Integrated” means that these components are formed from a single piece of material, which is preferably polychloropene. The polychloroprene or other material is preferably die cut into the designed shape. As shown, the integrated leash extender 10 is a single piece with no seams. It is understood, however, that the single piece may have attachments to itself. Wrist loop 12 and/or handle loop 14 may loop around and attach to extension 16 through stitching, gluing, or any other means commonly used in the art.

Each of wrist loop 12 and handle loop 14 are substantially round, as noted above. “Substantially round” includes, non-exclusively, circles, ellipses, egg-shapes, ovals, and importantly, any of the foregoing where the shape may appear slightly stretched toward a certain point. “Substantially round” does not include any straight edges or hard points and angles. In the embodiment shown, the substantial roundness of each is not perfect roundness, but appears to be slightly pulled toward extension 16. Even with this variation from perfect roundness, the substantial roundness includes no sharp edges or angles.

The leash extender 10 is made of a flexible material. The flexible material allows the leash extender of the present invention to stretch but not break upon stretching. It is preferred that the flexible material out of which the leash extender 10 is made is polychloropene, commonly known by the tradename NEOPRENE. It is an inherent characteristic of polychloropene that it will maintain its shape or bounce back into its shape after being manipulated.

Leash extender 10 has total length 50 as measured between wrist farthest point 52 and handle farthest point 54. Leash extender 10 also has extension length 30 as measured between wrist nearest point 56 and handle nearest point 58. Extension length 30 is a portion of total length 50, preferably 45-55%. While the dimensions of the various components of leash extender 10 may vary, one set of preferred dimensions has total length 50 at 9.96″ and extension length 30 at 4.78″.

Now referring to FIGS. 1B and 2A-2C, a side view and cross sections of wrist loop 12, extension 16, and handle loop 14 are provided, respectively. As shown most clearly in FIG. 1B, leash extender 10 has a fairly uniform height (shown as wrist, extension, and handle minor axes 34, 44, 38, as explained below), even if its various components may have different widths (shown in FIGS. 2A-2C as wrist, extension, and handle major axes 32, 42, 36). The wrist cross section 22, extension cross section 60, and handle cross section 24 are rounded and preferably oblong, as shown. “Rounded” means having no sharp edges. The oblong wrist cross section 22 has wrist major axis 32 and wrist minor axis 34. The oblong extension cross section 60 has extension major axis 42 and extension minor axis 44. The oblong handle cross section 24 has handle major axis 36 and handle minor axis 38. It is preferred that wrist minor axis 34, extension minor axis 44, and handle minor axis 38 all be equal, creating the uniform height of leash extender 10 as viewed from the side and as seen in FIG. 1B. It is further preferred that wrist major axis 32 and extension major axis 42 be equal and that handle major axis 36 be less than each. While the dimensions of the various components of leash extender 10 may vary, one set of preferred dimensions has wrist major axis 32 and extension major axis 42 at 0.75″; handle major axis 36 at 0.38″; and wrist minor axis 34, extension minor axis 44, and handle minor axis 38 all at 0.2″.

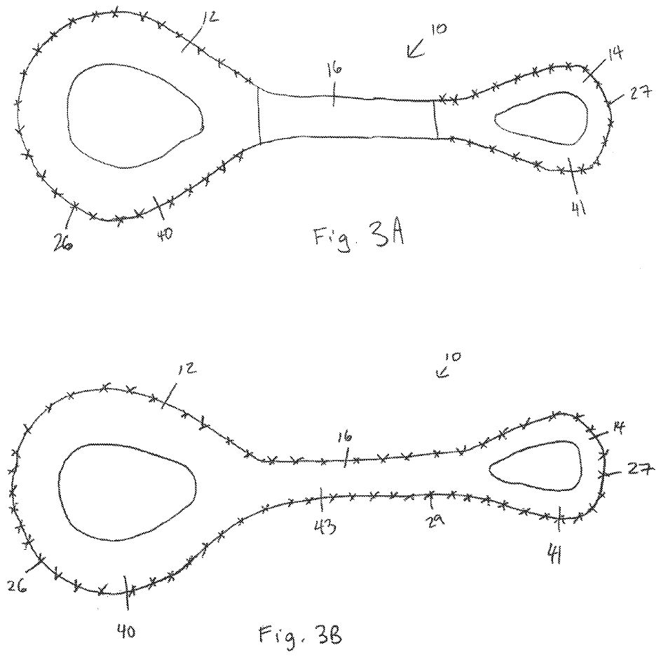

Now referring to FIGS. 3A and 3B, top down views of leash extender 10 including wrist padding 40 are provided. Wrist padding 40 is an extra layer disposed around wrist loop 12. This provides extra cushion for the user's wrist and also decreases wear and tear on the wrist loop 12. Wrist padding 40 is preferably made of elastane and is stitched within the polychloropene of wrist loop 12 with wrist padding stitching 26. It is understood that wrist padding stitching 26 is not necessarily disposed as shown around the outer perimeter of wrist loop 12, but shown as such merely as an exemplary illustration of where wrist padding stitching 26 could be. It is further understood that the line shown generally between wrist loop 12 and extension 16 may not be visible and is included to indicate where wrist padding 40 may be positioned within wrist loop 12 and where it might end with relation to extension 16. As shown, handle loop 14 may also include handle padding 41 with handle padding stitching 27. As shown in FIG. 3B, extension 16 may also include extension padding 43 with extension padding stitching 29. In such an embodiment, the respective paddings 40, 41, 43 are not necessarily separate components but may be a continuous piece of elastane, for example, that is incorporated into leash extender 10. Although stitching 26, 27, 29 is shown as the preferred means for incorporating the padding 40, 41, 43 into leash extender 10, it is understood that other means for such incorporation commonly used in the art, such as gluing, may also be utilized.

The leash extender 10 is wrapped around the handle of the leash and attached thereto by passing the wrist loop 12 through the handle loop 14. The leash extender 10 is then pulled tight for secure attachment to the leash handle. Once the wrist loop 12 is passed through the handle loop 14, it will bounce back to its soft, roundness, as discussed above. The wrist loop 12 will go around the walker's wrist. Its soft, rounded structure will be comfortable against the walker's skin and will not chafe if pulled tight, such as by a yanking dog.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

We claim:

1. A leash extender comprising:
a substantially round wrist loop;
a substantially round handle loop; and
an extension extending between said wrist loop and said handle loop;
wherein:
said wrist loop is bigger than said handle loop;
said leash extender is made of a flexible material;
said wrist loop comprises a rounded wrist cross section;
said handle loop comprises a rounded handle cross section; and
said extension comprises a rounded extension cross section.

2. The leash extender as claimed in claim 1, wherein said flexible material is polychloropene.

3. The leash extender as claimed in claim 2, wherein said wrist loop comprises wrist padding made of elastane disposed within said polychloropene.

4. The leash extender as claimed in claim 2, wherein said handle loop comprises handle padding made of elastane disposed within said polychloropene.

5. The leash extender as claimed in claim 3, wherein said handle loop comprises handle padding made of elastane disposed within said polychloropene.

6. The leash extender as claimed in claim 1, wherein said extension comprises extension padding made of elastane disposed within said polychloropene.

7. The leash extender as claimed in claim 5, wherein said extension comprises extension padding made of elastane disposed within said polychloropene.

8. The leash extender as claimed in claim 1, wherein:
said rounded wrist cross section is an oblong cross section comprising a wrist major axis and a wrist minor axis;
said rounded handle cross section is an oblong cross section comprising a handle major axis and a handle minor axis;
said wrist major axis is greater than said handle major axis; and
said wrist minor axis is equal to said handle minor.

9. The leash extender as claimed in claim 8, wherein:
said rounded extension cross section is an oblong cross section comprising an extension major axis and an extension minor axis;
said extension major axis is equal to said wrist major axis; and
said extension minor axis is equal to said wrist minor axis.

10. The leash extender as claimed in claim 1, further comprising:
a wrist farthest point disposed on said wrist loop as far away from said handle loop as possible;
a handle farthest point disposed on said handle loop as far away from said wrist loop as possible;
a total length extending between said wrist farthest point and said handle farthest point;
a wrist nearest point disposed on said wrist loop as close to said handle loop as possible;
a handle nearest point disposed on said handle loop as close to said wrist loop as possible; and
an extension length extending between said wrist nearest point and said handle nearest point;
wherein said extension length is 45-55% of said total length.

11. The leash extender as claimed in claim 1, wherein said wrist loop comprises wrist padding.

12. The leash extender as claimed in claim 11, wherein said wrist padding is elastane.

13. The leash extender as claimed in claim 12, wherein said elastane wrist padding is attached to said wrist loop with wrist padding stitching.

14. The leash extender as claimed in claim 11, wherein said handle loop comprises handle padding.

15. The leash extender as claimed in claim 14, wherein said handle padding is elastane.

16. The leash extender as claimed in claim 15, wherein said elastane handle padding is attached to said handle loop with handle padding stitching.

17. The leash extender as claimed in claim 1, wherein said handle loop comprises handle padding.

18. The leash extender as claimed in claim 1, wherein said extension comprises extension padding.

19. The leash extender as claimed in claim 14, wherein said extension comprises extension padding.

20. The leash extender as claimed in claim 1, wherein said wrist loop, said handle loop, and said extension are integrated.
